(19) United States
(12) Patent Application Publication
(10) Pub. No.: US 2002/0163709 A1
(43) Pub. Date: Nov. 7, 2002

(54) Method and apparatus for detecting and latching the position of a MEMS moving member

(76) Inventor: Amir Raza Mirza, Fremont, CA (US)

Correspondence Address: Dike, Bronstein, Roberts & Cushman, Intellectual Property Practice Group, EDWARDS & ANGELL, LLP, P.O. Box 9169, Boston, MA, 02209, US

(21) Appl. No.: 10/137,857

(22) Filed: May 3, 2002

Related U.S. Application Data
(60) Provisional application No. 60/288,591, filed on May 4, 2001.

(51) Int. Cl. G02B 26/00; G02B 7/02

(52) U.S. Cl. 359/295; 359/292; 359/291

(57) ABSTRACT

An apparatus for detecting the position of an optical element includes an actuator coupled to the optical element. A sensor coupled to the optical element senses the movement of the optical element. The sensor includes a moveable electrode coupled to the optical element for outputting a position detection signal.

### CROSS REFERENCE TO RELATED APPLICATIONS

This application claims priority from provisional application Serial No. 60/288,591 filed on May 4, 2001.

### FIELD OF THE INVENTION

This invention relates to MEMS devices and in particular, to a method and apparatus for detecting the position, a moving MEMS member and in turn an optical element, and latching the MEMS member in a predetermined position.

### BACKGROUND OF THE INVENTION

MEMS devices are now being used in the prior art. By way of example, as shown in FIGS. 1A and 1B. A beam 14 made of a material with a relatively high coefficient of thermal expansion is known in the art, such that when a voltage is applied across beam 14 it will expand. Beam 14 is anchored at each end by respective anchors 10,12. One of anchors 10,12 is a voltage source and the other anchor 10,12 is grounded so that a voltage is applied across beam 14 causing beam 14 to expand. Also because beam 14 is anchored, and slightly bowed, it will expand in a direction as shown by the top head of double-headed arrow A (FIG. 1B) while a voltage is applied by anchor 10. Conversely, when the voltage is removed the material of beam 14 cools and will return to its pre-expanded position. A moveable mass 18 is coupled to beam 14 by a linkage 16. Mass 18 may carry an optical element 20 such as a mirror, a shutter, an attenuator or the like. Accordingly, as can be seen, as is known from the art, an optical element 20 can be moved in reciprocating motion of arrow A by applying a voltage at anchor 10 heating beam 14 and then removing the voltage from anchor 10 to allow beam 14 to cool and return to its original state.

Reference is made to FIGS. 1B, 1C in which another embodiment of a moveable MEMS element is provided. Like elements are utilized to describe like structure for ease of description, the primary difference being the substitution of a comb electrode configuration for the thermal actuator of apparatus 10.

An apparatus 15 includes a moveable mass 18, having an optical element 20 thereon. Mass 18 is coupled to an actuator 11 by linkage 16. Actuator 11 includes a first comb 21 electrode having projections 22 and a second interlaced comb electrode 23 having projections 24. The projections 24 extend from a bar 26 which in turn is anchored to anchors 26 by respective arms 25. Anchors 26 are grounded so that when a voltage is applied to comb 21 it attracts projections 24 of comb 23, flexing arms 25, and causing linkage 16, which is attached to bar 27 (FIG. 1D). When voltage is removed the rigidity of arms 25 return bar 27 to its original position (FIG. 1C).

The prior art has been satisfactory, however, the prior art does suffer from the disadvantage that it assumes that optical member 20 is either in one of two positions. There is no way of determining the exact position of optical member 20 if, for example, beam 14 degrades over time. Furthermore, the system shown in FIGS. 1A, 1D are in fact a binary system designed to move only between one of two positions. However, with the advent of attenuators which incrementally move between a first and second position, it becomes necessary to monitor the position of the movable member.

Furthermore, in order to maintain the optical member 20 in an activated position as shown in FIG. 1B a voltage must be continuously applied across beam 14. This requires the use of excessive energy and a release of excessive heat which may eventually damage the optical circuit.

Therefore, it is desirable to provide an actuator and system for maintaining the actuation which overcomes the shortcomings of the prior art.

### SUMMARY OF THE INVENTION

The subject invention overcomes the deficiencies of the prior art by providing an apparatus and method for monitoring the position of an actuated member as well as an apparatus for latching the actuated optical member in a desired position. The apparatus includes an actuator as known in the art. An optical member is coupled to the actuator by a link. A sensor is coupled to the optical member for detecting the motion of the optical member and outputting a position detection signal in response thereto. The sensor includes a first electrode coupled to the optical member so as to move therewith upon actuation of the actuator.

A second electrode may be disposed adjacent the first electrode and a third electrode is disposed on an opposed side of the first electrode so that the first electrode moves between the second electrode and third electrode upon movement of the optical member. A first capacitor is coupled between the first electrode and the second electrode. A second capacitor is coupled between the first electrode and the third electrode. A measuring circuit measures the difference in capacitance between the first capacitor and the second capacitor and determines the position of the optical member in response thereto.

In accordance with another embodiment of the invention, the optical member is formed with extensions. Silicon stops which move in a direction into and out of the path of movement of the optical member are provided adjacent the optical member so that when the stops are disposed within the movement path of the optical member, the stop contacts the extension to engage the extension; preventing further movement of the optical member along its path.

This invention accordingly comprises the features of construction, combination of elements, arrangement of parts, and steps for performing a method in conformity therewith, which will be exemplified in the disclosure.

### BRIEF DESCRIPTION OF THE DRAWINGS

In the drawing figures, which are not to scale, and which are merely illustrative, and wherein like reference characters denote similar elements throughout the several views:

FIGS. 1A and 1B depict an exemplary electro-thermal MEMS actuator as known in the prior art in un-energized and energized positions, respectively;

FIGS. 1C and 1D depict an electrostatic MEMS actuator as known in a prior art in un-energized and energized positions, respectively;

FIG. 2A is a top plan view of a silicon actuator whose position can be detected according to the present invention;

FIG. 2B is simplified schematic electrical view of switched capacitor circuit which can be used to determine the position of the actuator;

FIG. 3 is an electrical schematic view of a movable member position sensing circuit which can control output voltage as a function of a capacitance which may vary and a reference capacitance;

FIG. 4 is an electrical schematic view of a movable member control closed-loop circuit, which includes a feedback loop for position control; and

FIG. 5 is a top plan view of a latch structure which can be used with a MEMS moving member.

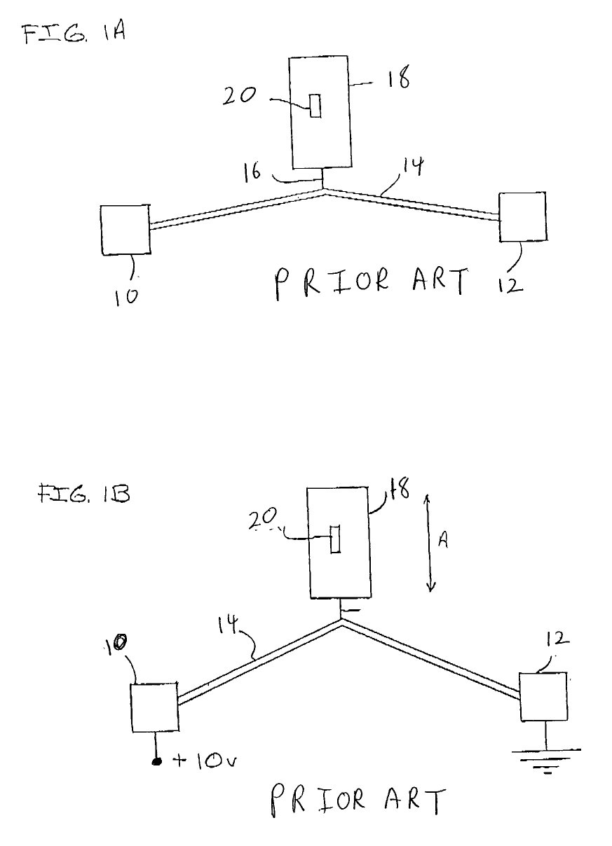

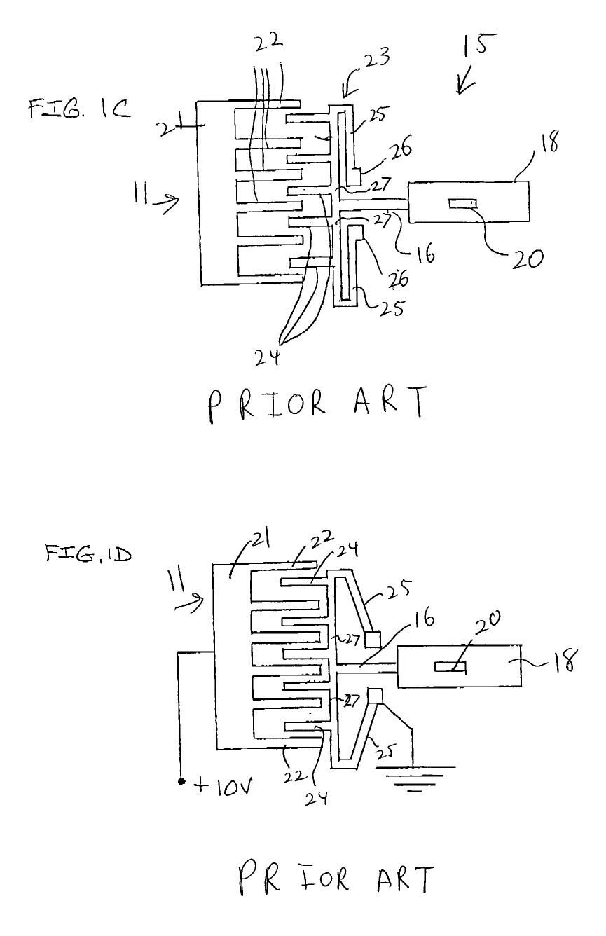

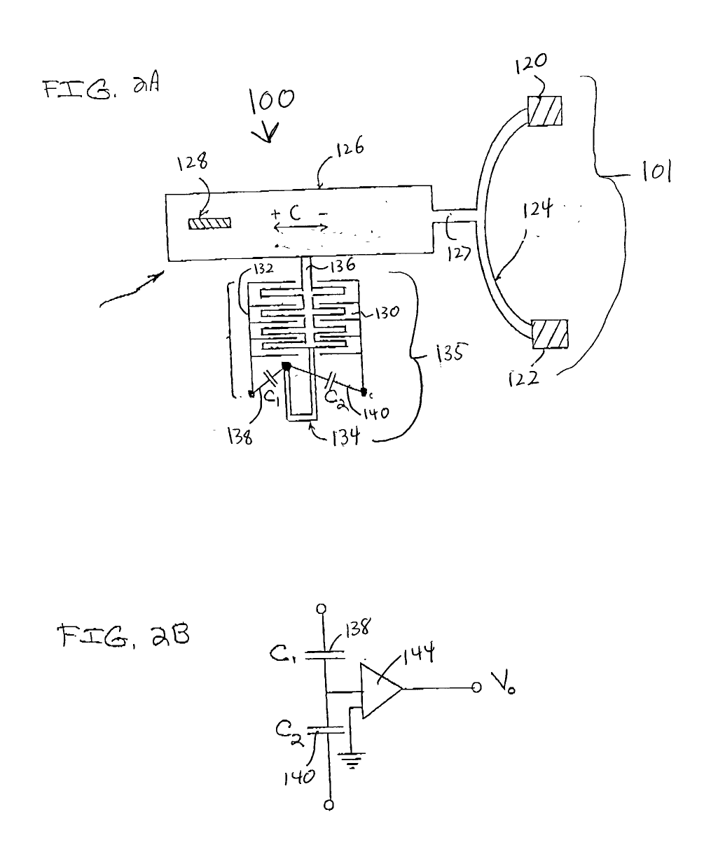

### DETAILED DESCRIPTON OF THE PREFERRED EMBODIMENTS

Systems integrators of optical MEMS devices having movable members wish to know the exact position of a movable member for control of the optical element; not merely that the movable member has been shifted between one of two particularly desired positions. The present invention measures the position of the movable mass utilizing electrodes and capacitors coupled to the movable mass, and determining the mass's position by measuring voltage differences across capacitors.

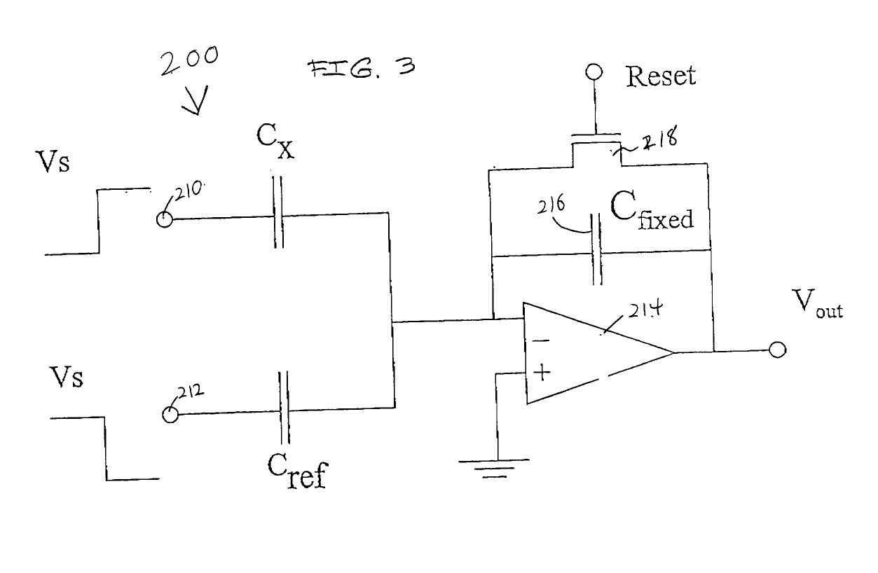

Reference is specifically made to FIGS. 2A and 2B. Apparatus 100 includes a thermal actuator 101 having a heated beam 124 anchored between a first anchor 120 and a second anchor 122 such that when a voltage is applied across anchors 120, 122 beam 124 heats and expands causing expansion of the beam in the direction of the left handed arrow of double headed arrow B. Conversely, when no voltage is applied, as beam 24 cools, it returns to an initial position moving in the direction of the right handed arrow of double headed arrow B. A movable mass 126 made out of silicon or the like is coupled to beam 124 by a link 127 so that movable mass 126 expresses movement in the directions of double headed arrow C with movement of heated beam 124 in the direction of double headed arrow B. An optical member, such as a high aspect ratio MEMS mirror, attenuator, shutter or the like is disposed on movable mass 126 and moves relative to an optical path (not shown) of an optical circuit upon actuation of actuator 101.

It should be understood that actuator 101 is an electro-thermal actuator by way of example, but may also be a piezo electric actuator, electrostatic actuator, or other conventional actuators as known in the art. Furthermore, it is also understood that optical element 128 is placed on a moving silicon mass by way of example in this embodiment, and may in fact be directly linked to link 127 or in fact, link 127 may be sized and dimensioned to act as the optical element itself. In this embodiment as will be seen below, it is preferred that a moving mass 126 be used for ease of coupling with a sensor 135.

Sensor 135 is operatively coupled to moving mass 126, but could be just as easily coupled to link 127, actuator 101 or, if properly sized and dimensioned, optical element 128. Sensor 135 includes a first electrode 136 coupled to moving mass 126. Electrode 136 is movable so as to move with a movement of moving mass 126. The movement of electrode 136 defines a path of movement. A second electrode 132 is disposed on the movement path of electrode 136 at one end of the movement path. A third electrode 130 is disposed along the movement path at another end of the movement path so that as electrode 136 moves with moving mass 126, it moves between second electrode 132 and third electrode 130. A suspension member 134, in electrical contact with first electrode 136, is coupled to second electrode 132 across a first capacitor 138 and to third electrode 130 across a second capacitor 140.

As is known in the art, the voltage across the capacitor will be a function of the position of first electrode 136 relative to either of second or third electrodes 132, 130. Accordingly, because first electrode 136 moves with moving mass 126, and because movement of the electrodes relative to each other causes changes in capacitance across capacitors 138, 140; the change in capacitance across electrodes 138, 140 is a function of the movement of moving mass 126. Therefore, voltage differences across capacitors 138, 140 indicate the position of movable mass 126.

It should be noted, that in a preferred embodiment electrodes 130, 132 and 136 are comb electrodes with interlacing fingers allowing for close proximity of the electrodes to each other as moving mass 126 moves. However, it can be understood that the electrodes can be of other type, such as plate electrodes, as long as the electrodes maintain a spacing from each other no greater than that which allows a detection of a change in voltage which can be measured as a capacitance across capacitors 138, 140.

Reference is now made to FIG. 2B in which one example of a sensing circuit for outputting a voltage signal corresponding to a movement of moving mass 126 is provided. Resistors 138, 140 are coupled in series. Therefore, at the junction of capacitors 138, 140 a net capacitance C_{X} corresponds to the difference in capacitance across the two capacitors as a result of movement Δx of moving mass 126. The C_{X} is input to an amplifier 144 where it is input as a voltage signal. Amplifier 144 outputs an amplified voltage signal Vₒ corresponding to the position of electrode 136 relative to electrodes 132, 130 and in turn the position of moving mass 126, and further in turn optical element 128.

More specifically, in accordance with the present invention, movement of moving mass 126 by distance Δx creates a differential change in capacitance as Δx increases. For example, as electrode 136 moves in the direction of the left handed arrow head of double headed arrow C, the capacitance of first capacitor 138 increases while the capacitance across capacitor 140 decreases. Therefore, if the capacitance value C1, C2 of first capacitor 138 and second capacitor 140 are known then Δx can be determined.

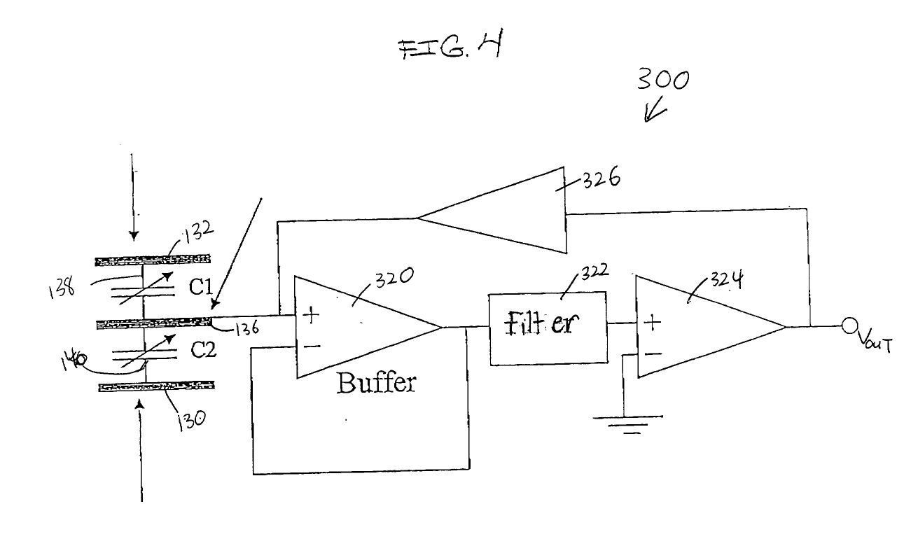

Reference is now made to FIG. 3 in which a circuit in which changes in capacitance can be converted to a voltage signal Vₒᵤₜ which allows the detection of the position of the movable mass 126 in response to the output voltage. The circuit of this embodiment, makes use of the following equation:

Vₒᵤₜ=Vₛ(C_{X}−C_{ref})/(C_{fixed}) (1)

It is possible to convert the voltage signal represented by the change of capacitance into a voltage out signal Vₒᵤₜ representing the position of mass 126 utilizing a circuit 200, which includes a input 210 for receiving the capacitance differential voltage signal corresponding to C_{X}. An input 212 receives a voltage input corresponding to a reference capacitance C_{ref}. These inputs provide a first input to a gain amplifier 214 which is grounded at its second input and is coupled in parallel with a second reference capacitor 216 having a fixed capacitance C_{fixed}. A reset switch 218 is coupled in parallel with fixed capacitor 216. As a result, a voltage signal input relating to the change in capacitance between electrodes 132, 136 and 130 can be compared with reference capacitance values to output a voltage signal Vₒᵤₜ which corresponds directly to movement of the mass 126, as well as the position.

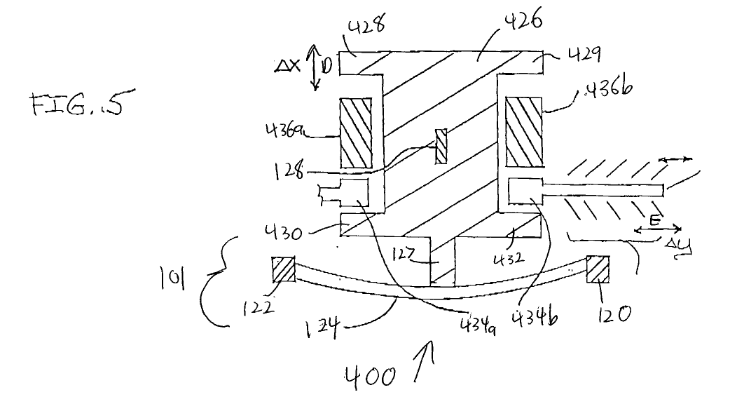

As a result of this structure of apparatus 100, the detection circuitry used to determine either the actuator position, or the optical element position can be simplified. The structure is particularly well suited for feedback control of an optical element which is particularly useful for attenuators and the like. By way of non-limiting example, one can measure the capacitance change resulting from movement of the MEMS device using a closed loop feedback circuit. Reference is now made to FIG. 4 in which a detection and control circuit 300 utilized to regulate the driving voltage which operates the actuator in order to equalize the two capacitances of the two capacitors, and thereby position the MEMS device precisely is provided. Like numerals are utilized to indicate like structure for ease of description.

Circuit 300 includes the three electrodes 136, 130 and 132 in which electrode 136 moves relative to fixed electrodes 130, 132, thus changing capacitance across capacitors 138, 140 respectively coupled therebetween as described in detail above. The capacitance differential C_{X} is input as a first input to a gain amplifier 320. The output of gain amplifier 320 is also input to amplifier 320 as its second input to provide a buffer. The output of amplifier 320 is also input to a filter 322 which in turn provides one input to a gain amplifier 324, the second input to gain amplifier 324 being coupled to ground. A diode 326 is coupled across the buffer 320, filter 322 and gain amplifier 324 to form a feedback loop so that the output Vₒᵤₜ is continuously input at the C_{X} input of amplifier 320. In this way, Vₒᵤₜ is continually adjusted as a result of the relative capacitance of capacitors 138, 140, which is an effect the position of movable mass 126. Vₒᵤₜ will keep changing until C_{X} is equal to zero, so that the actuator control voltage will hit a steady state when C_{X} equals zero.

As a result of the structure of apparatus 100 and the complimentary circuits 200 and the associated circuits 200 and 300 by way of example, the invention provides a precise method for detecting changes in Δx of movable mass 126. Furthermore, it becomes easy to calibrate the voltage Vₒ representing the voltage corresponding to the capacitance differential C_{X}. Therefore, it is very easy to calibrate Vₒᵤₜ as a function of Δx to obtain a Vₒᵤₜ signal for not only monitoring the position of movable mass 126, but for controlling the drive voltage Vₒᵤₜ for precisely positioning the movable mass 126 and in turn optical element 128.

The position of an optical member can thus be determined by monitoring the capacitance between a moving electrode, coupled to a moving mass, and a second electrode and comparing that to the capacitance between the moving electrode and the third electrode and comparing the relative capacitances at the moving electrode to produce a voltage signal corresponding to the position of the electrode. Furthermore, utilizing a feedback loop, the derived voltage signal can be used to position the optical member by outputting the detection signal as the drive signals to the actuator. In such a way, the position of the optical member can be closely controlled.

Once the position of the optical member can be determined and controlled with accuracy, it then becomes desirable to hold the optical member in a desired position. In known latched MEMS devices a movable member such as a mirror, shutter, attenuator or the like is often held in place utilizing an electrical charge across the device to maintain the heated beam or piezo electric device or electrostatic device in the activated position. Ideally there should be no voltage differential across the device. However, when maintaining the actuator position in the prior art, a voltage is continuously applied and voltage differentials occur internal to the MEMS device which can result in arcing and damage to the device.

In the apparatus of FIG. 5, a mechanical latch is used to hold the movable member in place. Again, like numerals are utilized to indicate like structure. An apparatus 400 includes an actuator 101 similar in construction to that discussed above in which a heated beam 124 is anchored between anchors 120, 122 and expands and contracts upon the application and removal of a voltage applied across anchors 120, 122. A movable mass 426 is coupled to beam 124 by a linkage 127.

Movable mass 426 has a main body 436 which is capable of motion in a path of motion in a direction shown by double headed arrow D. Extensions 428 extend from body 436 in a direction substantially orthogonal to the path of motion. Extensions 428, 429 are disposed at one end of body 436. Extensions 430, 432 extend from body 436 in a direction substantially orthogonal to the path of motion at the other end of body 436 so that movable member 426 is substantially in an I configuration. Optical element 128 is disposed on movable mass 426 so that as movable mass 426 moves in the direction of arrow D optical element 128 moves into and out of an optical path.

A mechanical latch is used to hold movable member 426 in place. By way of example, the mechanical latch is a movable stop 434a, which by way of example may also be made of silicon for ease of manufacture. Stop 434a is a shuttle member and moves in the direction of double headed arrow E to move into and out of the travel path of extension 430 by way of example. Stop 434a is shaped so as to engage extension 430 when in the travel path of extension 430. In an exemplary embodiment, silicon stop 434a is moved into position by a thermal scratch drive as known from the art as discussed by Akiyama and Shono in their article, “Controlled Step-wise Motion in Polysilicon Microstructures,” J. Microelectromech. Syst., vol. 2, pp. 106-110, 1993 and by Akiyama et al. in their article “Scratch Drive Actuator with Mechanical Links for Self Assembly of Three Dimensional MEMS,” J. Microelectromech. Syst., vol. 6, pp. 10-17.

As a result, through activation and deactivation of actuator 101 movable mass 426 will move in reciprocal motion in the direction of arrow D. At the same time, stop 434a can move between a first position out of the path of movement of extension 430 to a second position within the path of movement of extension 430. It is readily understood, that stop 434a is shaped to engage extension 430 when stop 434a is within the travel path of extension 430 and actuator 101 has been deactivated causing mass 426 to move in the direction of upper arrow double headed arrow D. Therefore, when energy is removed from actuator 101 the movable mass 426 is latched, held in place, by the engagement of stop 434a and extension 430.

In a preferred embodiment, although not necessary, a second stop 434b, also moved by a scratch drive mechanism, to move between a first position and a second position and back again in the direction of double headed arrow E, is provided to engage extension 432 when latching is desired. By providing two stops 434a, 434b less stress is placed upon extension 430 and stop 434a and to provide more stability to the overall apparatus.

It also should be readily understood from the above that to return movable mass 426 to an unlatched position the scratch drive moves stops 434a, 434b to withdraw stops 434a, 434b from the travel path of extensions 430, 432 allowing movement of mass 426 in the direction of the upper arrow head of double headed arrow D. As a result, in order to latch the position of optical member 126, it is not required to maintain a voltage across actuator 101.

Moveable stops 434a, 434b prevent the MEMS member from moving. Once the stops are in position, the electrical bias is no longer applied and the scratch drive may also be switched off. As a result, there is no bias applied from the moving mass contacting the stops. When the latch is actuated, the stops are held in compression. This arrangement is desirable because silicon, a prevalent material for MEMS, is much stronger in compression than tension. Additionally, all bias, both to the scratch drive and the thermal actuated beam 124 may be switched off when the stops are in place. As a result, optical member 128 stays in position in the absence of power.

An additional feature of the embodiment is the use of stationery stops 436a, 436b permanently situated along the travel path of extensions 430, 432 and 428, 429 and between extensions 428, 430 and 429, 432 respectively. In the absence of the latching feature of stops 430a, 434b, stationery stops 436a, 436b will come in contact with extensions 428, 430 and 429, 432 respectively if beam 124 over extends itself (over flexes) in either direction of arrow D. As a result, stops 436a, 436b engage the extensions in either direction to prevent over shooting movement of optical member 128.

While there have been shown and described and pointed out fundamental novel features of the invention as applied to preferred embodiments thereof, it will be understood that various omissions and substitutions and changes in the form and details of the disclosed invention may be made by those skilled in the art without departing from the spirit and scope of the invention. It is the intention, therefore, to be limited only as indicated by the scope of the claims appending hereto.

What is claimed is:

1. An apparatus for detecting the position of an optical element comprising:
an optical element;
an actuator coupled to said optical element for causing said optical element to move between at least a first position and a second position;
a sensor coupled to set said optical element for detecting the motion of said optical element and outputting a position detection signal in response thereto, the sensor including a movable electrode coupled to said optical member.

2. The apparatus of claim 1, wherein said moveable electrode travels along a travel path with said optical member, and further comprising a second electrode within said travel path, a first capacitor coupled between said moveable electrode and said second electrode for measuring the capacitance between said moveable electrode and second electrode, and a third electrode disposed in said travel path such that said moveable electrode is disposed between said second electrode and third electrode; a capacitor coupled between said moveable electrode and third electrode, the sensor determining a difference in capacitance between the first capacitor and the second capacitor and determining the position of the optical element in response thereto.

3. The apparatus of claim 2, wherein said moveable electrode, second electrode and third electrode are comb electrodes.

4. The apparatus of claim 2, further comprising a circuit coupled to said first capacitor and second capacitor for converting said difference in capacitance into a voltage signal corresponding to the position of the optical member.

5. The apparatus of claim 4, wherein the voltage signal is output to said actuator to control said actuator and said voltage signal is input to said circuit as a feedback loop so that the control signal is modified in response to the voltage.

6. The apparatus of claim 1, further comprising a base; said optical element being disposed on said base and said first electrode being coupled to said base.

7. The apparatus of claim 6, wherein said base is movable along a path of motion in response to actuation of said actuator, and said base further comprising a first extension extending from said base in a direction substantially orthogonal to said path of motion; and a stop movable, in a direction substantially orthogonal to said path of motion of said base, between a first position outside of the path of motion and a second position within the path of motion, said stop engaging said extension when in said second position to latch said base at a position along the path of motion.

8. The apparatus of claim 7, wherein said base is formed with a second extension on an opposed side of said base from said first extension, said second extension extending in a direction substantially orthogonal to the path of motion of the base; a second stop, movable along a direction substantially orthogonal to said path of motion of the base, between a first position outside of the path of motion and a second position within the path of motion, so that the second stop latches the base at the position along the path of motion.

9. The apparatus of claim 1, wherein said base moves along a path of motion, said base further comprising an extension extending from one end of said base in a direction substantially orthogonal to said path of motion; a second extension at an opposite end of said base extending from said base in a direction substantially orthogonal to said path of motion, and said apparatus further comprising a stationery stop disposed along said path of motion between said first extension and second extension at a position which prevents over actuation of said actuator.

10. An apparatus for latching a MEMS optical element comprising:
an actuator;
a base coupled to said actuator;
said base being movable between a first position and a second position along a path of movement in response to activation and deactivation of said actuator; an extension extending from one side of said base in a direction substantially orthogonal to the path of motion;
an optical element disposed on said base;
a movable stop moving in a direction substantially orthogonal to said path of motion between a first position outside of the path of motion and at least a second position within the path of motion for engaging said extension when, said moveable stop is in said second position and said actuator being in a deactivated state.

11. The apparatus of claim 10, wherein said base further comprises a second extension extending from an opposite side of the base in a direction substantially orthogonal to the direction of motion; and said apparatus further comprising a stop movable, along a direction substantially orthogonal to said path of motion, between a first position, in which said stop is not within said path of motion, and a second position, in which said stop is disposed within said path of motion, and engaging said second extension when said stop is in said second position and said actuator being in a deactivated state.

12. The apparatus of claim 11, further comprising a third extension extending in a direction substantially orthogonal to the path of motion; said apparatus further comprising a stationery stop disposed in the path of motion between said first extension and third extension.

13. An apparatus for preventing undesired movement of an optical MEMS element comprising:
an actuator;
a base coupled to said actuator and capable to being moved along a path of motion in response to the activation and deactivation of said actuator;
said base including a first extension extending from said base in a direction substantially orthogonal to the direction of motion;
and a second extension spaced from said first extension and extending from said base in a direction substantially orthogonal to said path of motion;
an optical element disposed on said base; and
a stationery stop disposed in said path of motion between said first extension and said second extension.

14. A method for detecting the position of a moveable optical element moved by an actuator comprising the steps of:
coupling a moveable electrode to said optical element, so that the moveable electrode moves with the optical element along a path;
providing a second electrode along the path;
providing a third electrode along the path, the moveable electrode being disposed between the second and third electrodes;
measuring the capacitance between the moveable electrode and the first electrode;
measuring the capacitance between the moveable electrode and third electrode; and
obtaining a difference between the two measured capacitances and producing a position detection signal in response thereto.

15. The method of claim 14, wherein said position detection signal is a voltage signal corresponding to said difference in capacitances, and further comprising the step of applying the voltage to the actuator.

16. The method of claim 14, further comprising the step of utilizing said voltage signal to position said optical element at a position where the difference in capacitance is zero.
